(19) United States
(12) Patent Application Publication
(10) Pub. No.: US 2024/0165724 A1
(43) Pub. Date: May 23, 2024

(54) ELECTRICAL DISCHARGE MACHINING SYSTEM WITH INTEGRATED FLUSHING

(71) Applicant: General Electric Company, Schenectady, NY (US)

(72) Inventors: James Scott FLANAGAN, Greenville, SC (US); Weston Michael SUCHENSKI, Greenville, SC (US); John D. PITTARD, Greenville, SC (US)

(21) Appl. No.: 18/057,899

(22) Filed: Nov. 22, 2022

(51) Int. Cl. B23H 1/04; B23H 1/10; B23H 7/26

(52) U.S. Cl. CPC B23H 1/04; B23H 1/10; B23H 7/265; B23H 2400/10

(57) ABSTRACT

The present application provides an electrical discharge machining system for drilling a hole in a workpiece using a flushing fluid. The electrical discharge machining system may include an electrode with the electrode positioned in an electrode guide, and an integrated external flushing system. The integrated external flushing system may include a guide cap and a concentric flushing channel defined between the guide cap and the electrode guide so as to allow the flushing fluid to remain attached to the electrode guide.

### TECHNICAL FIELD

The present application and the resultant patent relate generally to an electrical discharge machining system and more particularly relate to an electrical discharge machining system with integrated electrode flushing in order to reduce overall break out time.

### BACKGROUND OF THE INVENTION

Electrical discharge machining (EDM) is a manufacturing process whereby shapes are formed in a workpiece using electrical discharge, i.e., sparks. A tool electrode is placed proximate to the workpiece and an electrical voltage is applied between the tool electrode and the workpiece. When the intensity of the electric field between the tool electrode and the workpiece exceeds the resistance of the dielectric medium therebetween, a current flows from the electrode to the work piece, or vice versa, removing some material from both the electrode and workpiece.

EDM drilling is a highly reliable process to form cooling holes and fuel injection holes in turbine components (e.g., airfoils and the like). As such, EDM drilling is widely used in the turbine industry. EDM drilling, however, may be relatively slow, particularly given a buildup of debris in the partially drilled hole. Specifically, flushing water may flow through the center of an EDM electrode during drilling. Once the electrode breaks out, however, the flushing water through the center of the electrode may not be able to carry away the EDM waste or debris on the exterior of the electrode in a sufficiently fast and efficient manner.

### SUMMARY OF THE INVENTION

The present application and the resultant patent provide an electrical discharge machining system for drilling a hole in a workpiece using a flushing fluid. The electrical discharge machining system may include an electrode with the electrode positioned in an electrode guide, and an integrated external flushing system. The integrated external flushing system may include a guide cap and a concentric flushing channel defined between the guide cap and the electrode guide so as to allow the flushing fluid to remain attached to the electrode guide.

The present invention and the resultant patent further provide a method of reducing debris about an electrode while drilling a hole in a workpiece with an electrical discharge machining system. The method may include the steps of drilling the hole with the electrode, flowing flushing fluid through an internal flushing chamber within the electrode, flowing flushing fluid through an integrated external flushing system about an electrode guide, and continuing to flow flushing fluid through the integrated external flushing system as the electrode breaks out of the workpiece.

### BRIEF DESCRIPTION OF THE DRAWINGS

FIG. 1 is a schematic diagram of an exemplary electrical discharge machining system.

FIG. 2 is a further schematic view of the electrical discharge machining system of FIG. 1

FIG. 3 is a schematic view of the electrical discharge machining system of FIG. 1 in use.

FIG. 4 is a further schematic view of the electrical discharge machining system of FIG. 1 in use.

FIG. 5 is a schematic view of an integrated external flushing system as may be described herein.

FIG. 6 is a schematic view of the integrated external flushing system of FIG. 5 in use.

FIG. 7 is a further schematic view of the integrated external flushing system of FIG. 5 in use.

FIG. 8 is a further schematic view of the integrated external flushing system of FIG. 5 in use.

### DETAILED DESCRIPTION

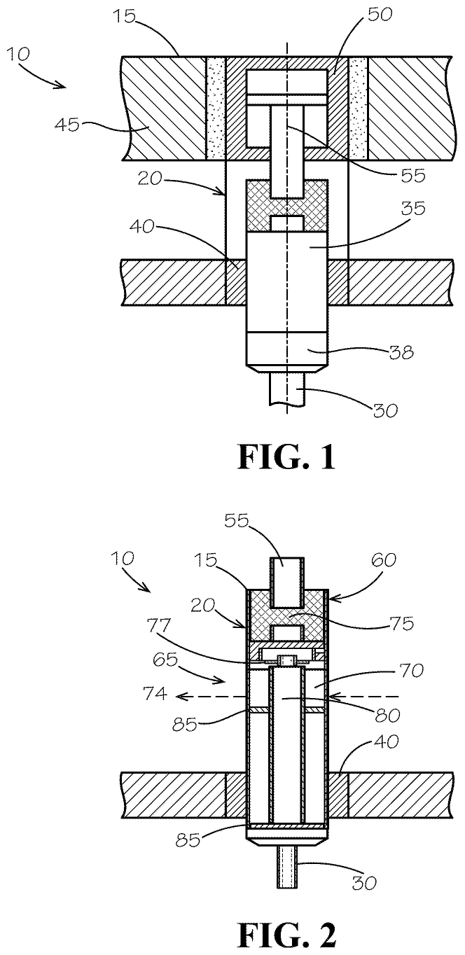

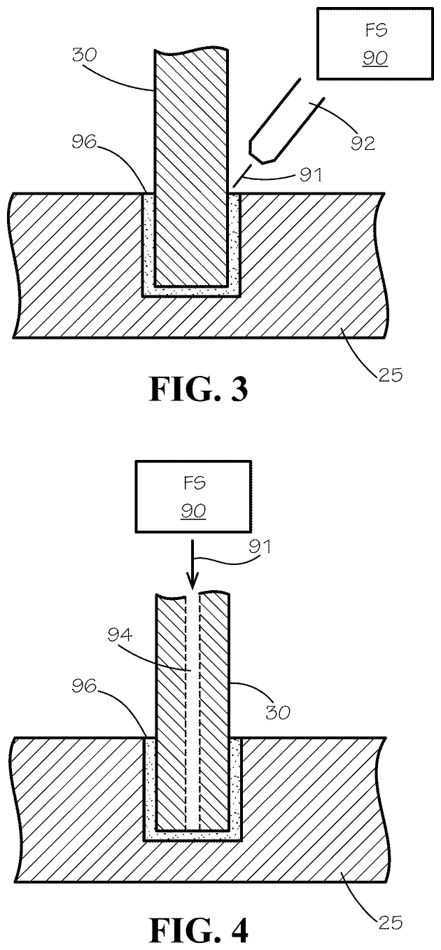

Referring now to the drawings, in which like numerals refer to like elements throughout the several views, FIGS. 1 and 2 are schematic diagrams of a portion of an electrical discharge machining (EDM) system 10. As shown, the EDM system 10 may include a guide structure 15 and one or more electrode devices 20 positioned at least partially within the guide structure 15. The electrode devices 20 provide an electrical discharge to a workpiece 25, e.g., a turbine component such as a gas turbine airfoil. (Shown in FIGS. 3 and 4). Each of the electrode devices 20 include an electrode 30 for positioning about (e.g., contacting or nominally separated from) the workpiece 25. An electrode guide 35 may be coupled to the electrode 30 for holding the electrode 30 proximate to the workpiece 25.

The electrode device 20 may be positioned within a slide bearing 40 and a back plate 45. The electrode device 20 may be driven via a drive 50 and a piston 55. The electrode device 20 further may include a rotating tube electrode device 60. The rotating tube electrode device 60 may be coupled to the piston 55. The rotating tube electrode device 60 further may include a pneumatic rotary driver 65 including an air motor 70 (having compressed air inlet 72 and outlet 74), a water inlet 75 upstream of the air motor 70 (with adjacent seal 77), and a rotor 80 coupled with the air motor 70 (where rotor 80 is supported on bearings 85). In this configuration, the rotating tube electrode device 65 may rotate the electrode 30 while the piston 55 drives the electrode 30 toward and away workpiece 25. This rotating tube electrode device 60 shown herein thus may be useful in forming holes in the workpiece 25 in spaces requiring minimal clearance.

The EDM system 140 further may include a fluid source 90 for flushing the electrode 30. By way of example, side flushing is illustrated in FIG. 3, where a flushing fluid 91 is introduced to an external surface of electrode 30 from a side region, via a nozzle 92. FIG. 4 shows the flushing fluid 91 introduced through the body of the electrode 30 via an internal flushing chamber 94. As described above, the methods may be slowed upon break out as the flushing fluid 91 is not able to efficiently carry away the EDM waste.

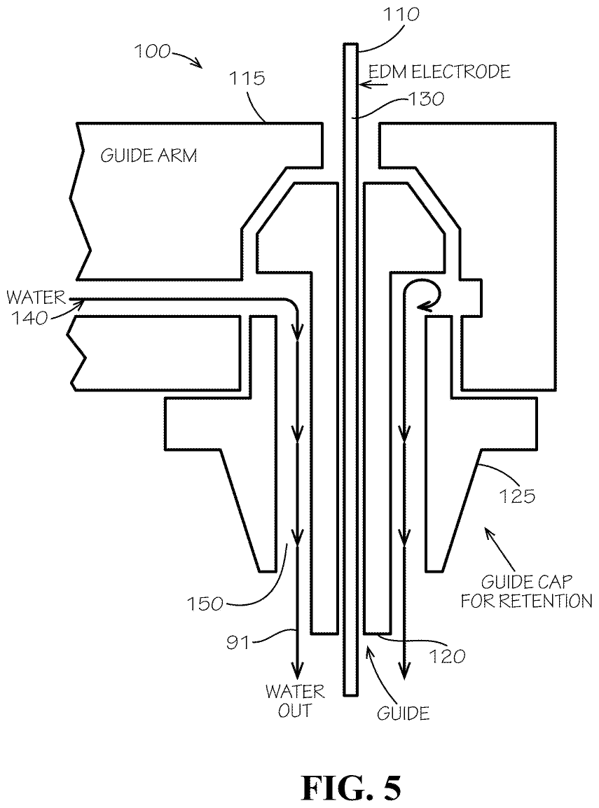

FIG. 5 shows portions of an EDM machining system 100 as may be described herein. The EDM machining system 100 may include an electrode 110 positioned within an electrode guide 120. The electrode 110 may be of conventional design and may have any suitable size, shape, and configuration herein. The electrode guide 120 may be largely tubular in shape with any suitable size, shape, or configuration. The electrode guide 120 may be supported by a guide arm 115 on one end and a guide cap 125 on the other. Other types of supports may be used herein. The electrode 110 may include an internal flushing chamber 130 extending therethrough. The internal flushing chamber 130 may be in communication with the fluid source 90 or other source of a flushing liquid such as water and the like. The flushing fluid 91 flows into a hole 96 formed in the workpiece 25 as the electrode 30 progresses therethrough. Other components and other configurations may be used herein.

The EDM machining system 100 also may include an integrated external flushing system 140. The integrated external flushing system 140 may include a concentric fluid channel 150. The concentric fluid channel 150 may be defined by the electrode guide 120 and the guide arm 115 on one end and the guide cap 125 on the other. The concentric fluid channel 150 may be in communication with the fluid source 90 or a separate source of the flushing fluid. The concentric fluid channel 160 may have any suitable size, shape, or configuration. Specifically, the flushing fluid 91 may flow between the electrode guide 120 and the guide arm 115 and between the electrode guide 120 and the guide cap 125 along the length of the electrode guide 120. Other component and other configuration may be used herein.

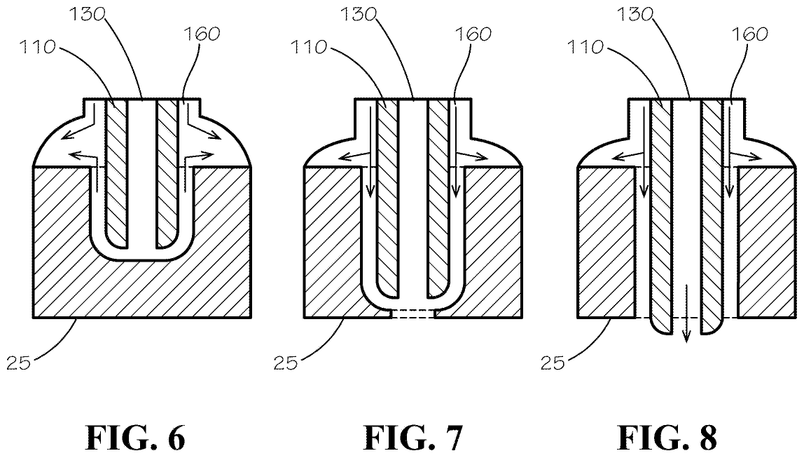

FIG. 6-8 show the integrated external flushing system 140 in use. As is shown in FIG. 6, as the electrode 110 begins drilling into the workpiece 25, flushing fluid 91 from the fluid source 90 extends through the internal flushing chamber 130 and carries away debris about the electrode 110. Likewise, the flushing fluid 91 from the integrated external flushing system 140 assist in carrying the debris away from the electrode 110 and the electrode guide 120. As is shown in FIGS. 7 and 8, once the electrode 110 begins to break out of the workpiece 25, the flushing fluid 91 from the integrated external flushing system 140 continues to carry away debris away from the electrode 110 and the electrode guide 120.

The use of the integrated external flushing system 140 thus allows the flushing fluid 91 to remaining attached to the electrode guide 120 and into the hole 96 as the electrode 110 proceeds into the workpiece 25. Specifically, the concentric fluid channel 150 allows the flushing fluid 91 to flow along the electrode guide 120 and into the hole 96. The integrated external flushing system 140 thus should reduce overall cycle time when breaking out of a hole 96 at shallow angle or otherwise. Specifically, about a fifty percent reduction in time spent dwelling after initial break out may be achieved herein. Moreover, overall wear on the electrode 110 may decrease. The integrated external flushing system 140 thus provides effective and repeatable flushing of debris while allowing the overall EDM system 100 to accommodate differently sized electrodes 110 therein.

It should be apparent that the foregoing relates only to certain embodiments of this application and resultant patent. Numerous changes and modifications may be made herein by one of ordinary skill in the art without departing from the general spirit and scope of the invention as defined by the following claims and the equivalents thereof.

Further aspects of the invention are provided by the subject matter of the following clauses:

1. An electrical discharge machining system for drilling a hole in a workpiece using a flushing fluid, comprising: an electrode; the electrode positioned in an electrode guide; and an integrated external flushing system; the integrated external flushing system comprising a guide cap and a concentric flushing channel defined between the guide cap and the electrode guide so as to allow the flushing fluid to remain attached to the electrode guide.

2. The electrical discharge machining system of any preceding clause, wherein the integrated external flushing system comprises a flushing fluid source in communication with the concentric flushing channel.

3. The electrical discharge machining system of any preceding clause, wherein the electrode comprises an internal flushing system.

4. The electrical discharge machining system of any preceding clause, wherein the internal flushing system is in communication with the flushing fluid source.

5. The electrical discharge machining system of any preceding clause, wherein the electrode guide accommodates a plurality of differently sized electrodes.

6. The electrical discharge machining system of any preceding claim, wherein the integrated external flushing system comprises a guide arm supporting the electrode guide.

7. The electrical discharge machining system of any preceding claim, wherein the concentric flushing channel extends between the electrode guide and the electrode arm in part.

8. The electrical discharge machining system of any preceding clause, further comprising a piston in communication with the electrode.

9. The electrical discharge machining system of any preceding clause, further comprising a rotating tube system in communication with the piston.

10. A method of reducing debris about an electrode while drilling a hole in a workpiece with an electrical discharge machining system, comprising: drilling the hole with the electrode; flowing flushing fluid through an internal flushing chamber within the electrode; flowing flushing fluid through an integrated external flushing system about an electrode guide; and continuing to flow flushing fluid through the integrated external flushing system as the electrode breaks out of the workpiece.

We claim:

1. An electrical discharge machining system for drilling a hole in a workpiece using a flushing fluid, comprising:
an electrode;
the electrode positioned in an electrode guide; and
an integrated external flushing system;
the integrated external flushing system comprising a guide cap and a concentric flushing channel defined between the guide cap and the electrode guide so as to allow the flushing fluid to remain attached to the electrode guide.

2. The electrical discharge machining system of claim 1, wherein the integrated external flushing system comprises a flushing fluid source in communication with the concentric flushing channel.

3. The electrical discharge machining system of claim 2, wherein the electrode comprises an internal flushing system.

4. The electrical discharge machining system of claim 3, wherein the internal flushing system is in communication with the flushing fluid source.

5. The electrical discharge machining system of claim 1, wherein the electrode guide accommodates a plurality of differently sized electrodes.

6. The electrical discharge machining system of claim 1, wherein the integrated external flushing system comprises a guide arm supporting the electrode guide.

7. The electrical discharge machining system of claim 6, wherein the concentric flushing channel extends between the electrode guide and the guide arm in part.

8. The electrical discharge machining system of claim 1, further comprising a piston in communication with the electrode.

9. The electrical discharge machining system of claim 8, further comprising a rotating tube system in communication with the piston.

10. A method of reducing debris about an electrode while drilling a hole in a workpiece with an electrical discharge machining system, comprising:
drilling the hole with the electrode;
flowing flushing fluid through an internal flushing chamber within the electrode;
flowing flushing fluid through an integrated external flushing system about an electrode guide; and
continuing to flow flushing fluid through the integrated external flushing system as the electrode breaks out of the workpiece.
